(19) United States
(12) Patent Application Publication
(10) Pub. No.: US 2016/0245449 A1
(43) Pub. Date: Aug. 25, 2016

(54) Irrigation Pipe Coupling

(71) Applicant: Invention Services of Arizona, LLC, Gold Canyon, AZ (US)

(72) Inventor: Steven Karl Wolff, Mesa, AZ (US)

(73) Assignee: Invention Services of Arizona, LLC, Gold Canyon, AZ (US)

(21) Appl. No.: 14/631,508

(22) Filed: Feb. 25, 2015

(51) Int. Cl. F16L 55/18; F16L 21/00; F16L 25/00; F16L 23/036; F16L 23/16; F16L 31/00; F16L 21/08; F16L 23/00

(52) U.S. Cl. CPC F16L 55/18; F16L 21/08; F16L 21/007; F16L 23/006; F16L 23/036; F16L 23/16; F16L 31/00; F16L 25/009

(57) ABSTRACT

A coupling for joining pipe ends of opposing first and second pipes in end-to-end relation is disclosed. The coupling comprises a tubular member having opposing first and second ends and an intermediate extent defining an internal diameter. The first end receives the first pipe and the second end receives the second pipe. A pipe retainer secures each respective pipe end within the tubular member. The pipe retainer may comprise a first pipe clamp secured to the first pipe and a second pipe clamp secured to the second pipe. A clamp retainer bar has opposing ends with a first end secured to the first pipe clamp and a second end secured to the second pipe clamp. Alternatively, the pipe retainer may comprise compressive members threaded within threaded holes in the tubular member. The compressive members exert a compressional force upon the pipes to secure the pipes within the tubular member.

### TECHNICAL FIELD

The present invention relates generally to a device for coupling two pipes; more particularly to a device for coupling thin-walled pipes such as irrigation pipe; and most particularly to a device for coupling irrigation pipes in the field while requiring only the use of simple tools.

### BACKGROUND OF THE INVENTION

Farmers historically have had to fight the elements in order to harvest their crops and sell them at the highest possible price. One part of the growing equation is watering the fields. This may be done by any of a number of methods including water delivery via aluminum pipes. These pipes are generally about 20 to 40 feet in length and have diameters that range from 1½ to 12 inches depending upon the application and amount of water needed. Typically, successive pipes are joined by a spigot and bell coupling with the bell housing a rubber gasket to make a water-tight joint between the two pipes. As these pipes are long and cumbersome to move, the aluminum wall of the pipe is very thin in order to make each pipe as light as possible. However, thin-walled pipes pose a significant problem as the wall of the pipe may be so thin that it is readily damaged. Indeed, damage can occur simply from ordinary use, careless handling and deployment of the pipes or even due to vehicles driving over the pipes once the pipes are lying on the ground during use in the field.

When damage occurs there are generally three alternatives to remedy the situation. The first is to simply discard the damaged pipe and replace it with another. While this may solve the immediate problem, this solution is wasteful and would become cost prohibitive due to the additional costs needed to purchase or rent replacement pipes.

A second alternative is to weld the damaged portion of the pipe. However, this requires removal of the pipe from the field so that a highly skilled welder may repair the damaged portion off site. As the aluminum wall is extremely thin, such welding is typically beyond the skill possessed by most farmers. Also, water flow will need to be paused while repairs are made, thus incurring the cost problems associated with the first alternative.

Lastly, a damaged pipe may be repaired by using a specialized tool known in the art as a Henry Pipe Press. The Henry Pipe Press is a hydraulic machine that runs either on electricity or gas and is designed to be operated either in a repair shop or in the field depending on the power source. The press needs to be operated by a trained individual that possesses the required skill acquired through extensive training and practice in the art of making water tight joints. Specifically, the process of making the watertight joint entails placing the ends of the pipe to be repaired into the machine and having the machine make a series of rolled grooves and outward bends and then using the hydraulic pistons on the machine to make a series of bends and rolls to join the two pipes. This procedure is laborious and difficult to perform, especially with longer pipe sections, as the two sections of the pipe must be held straight while the machine performs the work. Thus, to do this in the field is quite difficult and time consuming as the machine takes one skilled operator and two individuals to hold the opposite ends of the pipe being repaired. Moreover, repairs using the Henry Pipe Press cannot be accomplished in the field while the ground is wet or when crops are growing.

In view of the above, it is clear that what is needed in the art is a coupling that can be utilized by one individual in a matter of minutes without the need for specialized training, expensive equipment or transportation of the damaged pipe from the field. The coupling should be light and assemble with very few hand tools and virtually no training.

### SUMMARY OF THE INVENTION

Briefly described, the present invention is directed to a coupling for joining pipe ends of opposing first and second pipes in end-to-end relation. In accordance with an aspect of the present invention, the coupling generally comprises a tubular member and a pipe retainer. The tubular member has opposing first and second ends and a sidewall of an intermediate extent thereby defining a hollow interior having a first internal diameter. The first end is adapted to receive and surround the pipe end of the first pipe while the second end is adapted to receive and surround the pipe end of the second pipe. The pipe retainer is configured to secure each respective pipe end within the tubular member. The tubular member may also include an internal annular projection wherein each of the opposing first and second pipe ends may be inserted within the tubular member until each respective tube end abuts the internal annular projection. The tubular member may further include respective first and second annular grooves located proximate respective first and second ends of the tubular member. Each annular groove may be configured to receive a respective pipe seal and the pipe seal may be comprised of an elastomeric material. The tubular member may also have a respective step portion proximate respective first and second ends of the tubular member. Each step portion may define a second internal diameter which is larger than the first internal diameter.

In accordance with an aspect of the present invention, the pipe retainer may comprise a first pipe clamp adapted to be releasably secured to the first pipe, a second pipe clamp adapted to be releasably secured to the second pipe, and a clamp retainer bar having opposing ends with a first bar end removably secured to the first pipe clamp and a second bar end removably secured to the second pipe clamp. Each pipe clamp may further include a flange member wherein respective bar ends are secured to respective flange members. Each bar end may also include an aperture therein wherein each bar end is secured to its respective flange member via a bolt and nut. One or both apertures may be configured as an elongated slot so as to accommodate expansion of the tubular member, the first pipe, the second pipe or any combination thereof. With this embodiment it will become apparent that different pipe materials can be used such as PVC's, high density polyethylene, low density polyethylene and all metals. Additionally, with this it will also become apparent that different fittings such as 90 degree and 45 degree offsets as well as tees and reducers can be formed as part of the tubular member.

In accordance with a further aspect of the present invention, the pipe retainer may comprise a plurality of threaded compressive members threadably inserted within corresponding threaded holes within the tubular member. The threaded compressive members are adapted to exert a compressional force upon the first and second pipes to releasably secure the pipes within the tubular member. The threaded compressive members may be set screws. The outer surface of the tubular member may also include a flattened portion wherein the threaded holes are located within the flattened portion.

### BRIEF DESCRIPTION OF THE DRAWINGS

The detailed description of some embodiments of the present invention is made below with reference to the accompanying figures, wherein like numerals represent corresponding parts of the figures.

FIG. 1 shows a perspective view of a tubular member amenable for use within a pipe coupling in accordance with an embodiment of the present invention;

FIG. 2 shows an end view of the tubular member shown in FIG. 1;

FIG. 3 is a cross sectional view of the tubular member shown in FIG. 1, taken generally along line 3-3 in FIG. 2;

FIG. 4 is an end view of a pipe coupling according to an embodiment of the present invention;

FIG. 5 is a cross sectional view of the pipe coupling shown in FIG. 4, taken generally along line 5-5 in FIG. 4;

FIG. 6 shows a perspective view of a tubular member amenable for use within an alternative pipe coupling in accordance with an embodiment of the present invention;

FIG. 7 shows an end view of the tubular member shown in FIG. 6; and

FIG. 8 is a cross sectional view of the tubular member shown in FIG. 6, taken generally along line 8-8 in FIG. 7.

### DESCRIPTION OF THE PREFERRED EMBODIMENTS

By way of example, and referring to FIGS. 4 and 5, an embodiment of the present invention comprises a pipe coupling 10 for joining pipe ends 12, 14 of opposing first and second pipes 16, 18. In accordance with an aspect of the present invention, pipe coupling 10 is meant to offer a simple and efficient alternative to repairing broken or damaged irrigation pipes or pipes designed for other above ground uses employed within the field. As such, first and second pipes 16, 18 may include cut and de-burred ends 12, 14 of a previously singularly whole length of pipe. To that end, pipe coupling 10 generally includes a tubular member 20 and a pipe retainer 22 adapted to join the two cut lengths of pipe so as to remove the damaged portion and reconstitute the previously water-tight length of pipe.

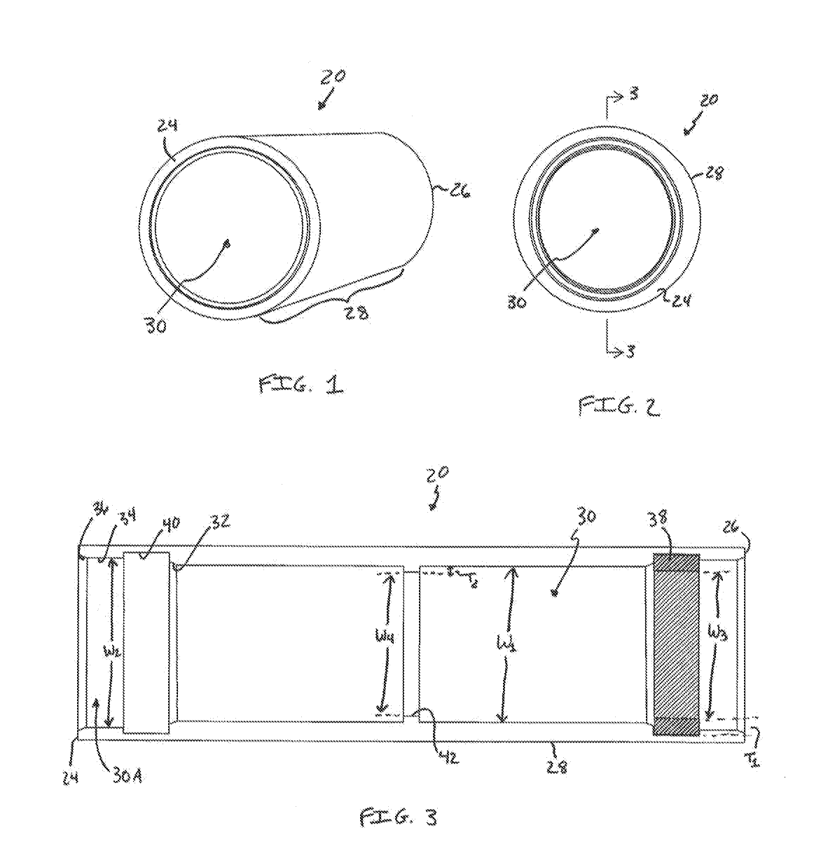

FIGS. 1-3 are various views of tubular member 20 which may be included within pipe coupling 10. As shown, tubular member 20 has opposing first and second ends 24, 26 and a sidewall 28 of an intermediate extent thereby defining a hollow interior 30 having an internal diameter W₁. First end 24 of the tubular member is adapted to receive and surround first pipe 16 while second end 26 is adapted to receive and surround second pipe 18 (see FIG. 5). In accordance with an aspect of the present invention, hollow interior 30 has a diameter W₁ that is proportioned so as to snuggly receive pipes 16, 18. That is, internal diameter W₁ is selected to be slightly larger than the external diameter D₁ of pipes 16, 18. Hollow interior 30 may also include a chamfered face 32 so as to aid passage of pipe 16, 18 into tubular member 20. Additionally or alternatively, to further aid in insertion of pipes 16, 18 tubular member 20 may be configured to include a step portion 34 wherein sidewall 28 has a reduced thickness thereby creating an expanded hollow interior portion 30A having an internal diameter W₂ being larger than internal diameter W₁. Step portion 34 may also include a chamfered face 36 between the step and tubular member ends 24, 26.

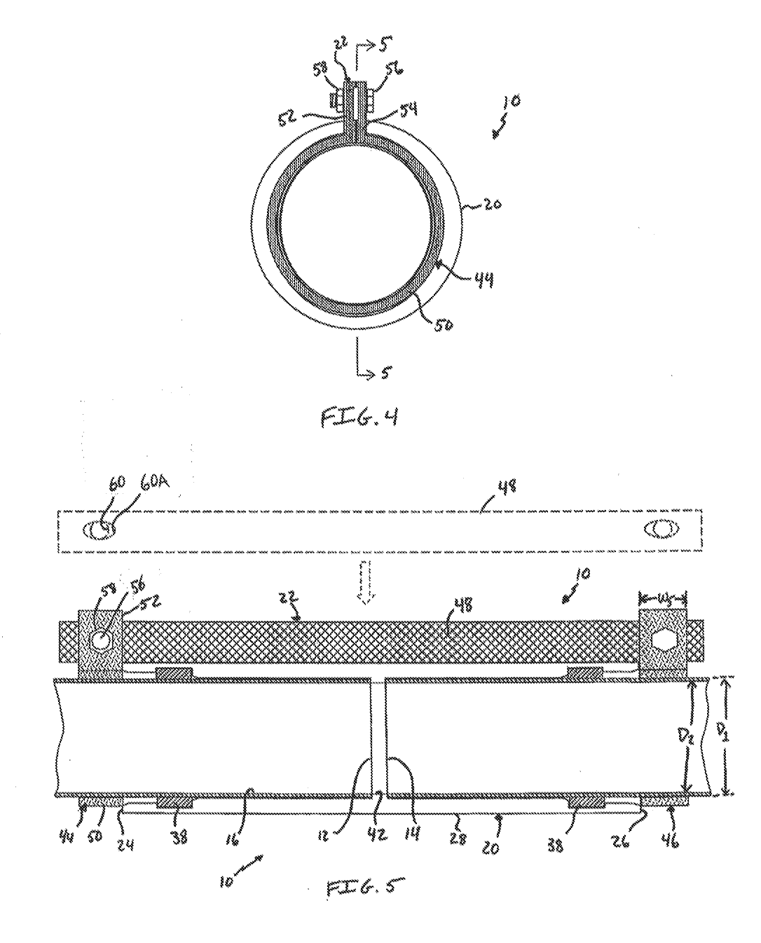

To prevent, or at least minimize the possibility for leakage of fluid, tubular member 20 may be further adapted to receive and house seals 38. It should be noted that tubular member 20 is shown with only one seal in FIG. 3 for illustrative purposes. It is envisioned that, in use, a seal 38 would be inserted proximate each end 24, 26 of tubular member 20 (as seen in FIG. 5) to maximize sealing efficiency between the coupling and the pipes while minimizing the potential for leakage. Seal 38 may be constructed of any suitable material, such as but not limited to an elastomeric material such as a natural or synthetic rubber or a thermoplastic. Specific examples not to be limited thereto include butadiene rubber, polytetrafluoroethylene rubber and silicon rubber. Tubular member 20 may include an annular groove 40 proximate each end 24, 26 within which seal 38 is seated. In this manner, lateral movement of seal 38 is prevented or minimized as pipe 16, 18 is slidably inserted into (or removed from) tubular member 20. Seal 38 is selected to have a thickness T₁ such that seal 38 forms a ring-shaped member having an internal diameter W₃ which is equal to or slightly smaller than internal diameter W₁ of tubular member 20 and/or external diameter D₁ of pipe 16, 18. In any event, seal 38 is selected to have a thickness and internal diameter so as to create a fluid-tight seal between seal 38 and pipe 16, 18.

Tubular member 20 may further include an internal annular projection 42 wherein, in one aspect of the invention, annular projection 42 is located approximately half way along the length of sidewall 28 so as to divide hollow interior 30 in generally equal portions. The position of annular projection 42 may vary to accommodate tees, offsets and reducers that may be formed as part of tubular member 20. Annular projection 42 may be configured to have a thickness T₂ which is generally equal to the wall thickness of the irrigation pipe (pipes 16, 18) so as to form a hollow portion having a reduced interior diameter W₄ which is generally equal to the internal diameter D₂ of pipe 16, 18 (see FIG. 5). In this manner, annular projection 42 provides a hard stop for pipe ends 12, 14 when inserting pipes 16, 18 within tubular member 20 while also minimizing any flow restrictions/turbulence experienced by the water or other fluid flowing within pipes 16, 18 and through pipe coupling 10.

Returning now to FIGS. 4 and 5, pipe coupling 10 includes a pipe retainer 22 configured to secure pipes 16, 18 within tubular member 20. Pipe retainer 22 generally includes a first pipe clamp 44, a second pipe clamp 46 and a clamp retainer bar 48. Pipe clamps 44, 46 may be substantially identical and therefore for illustrative purposes, reference will be made hereinafter only to pipe clamp 44. Pipe clamp 44 includes a body portion 50 having a generally circular cross section which is selected to define an internal diameter substantially equal to or slightly smaller than outer diameter D1 of pipe 16 such that, which secured under clamping pressure, lateral travel of pipe 16 within pipe clamp 44 is prevented. Pipe clamp 44 may include a pair of outwardly projecting flanges 52, 54 at opposing ends of the clamp body portion 50. Clamping pressure may be generated by drawing the flanges 52, 54 toward one another to thereby decrease the internal diameter defined by the body portion 50 until pipe clamp 44 is secured to pipe 16 as described above. To that end, flanges 52, 54 may include a hole (not shown) which is adapted to allow a bolt 56 to pass therethrough. Nut 58 can then be threaded onto bolt 56 and tightened until the desired clamping pressure is generated. It should be understood by those skilled in the art that, while clamp 44 has been shown and described as a single piece pipe clamp with a bolt/nut fastener, alternative clamps and fasteners may be utilized which produce satisfactory clamping pressures when secured to pipe 16 and that such alternatives are to be considered to be incorporated within the present teachings.

Secured between opposing pipe clamps 44, 46 is clamp retainer bar 48. Bar 48 is selected to have a length at least equal to the length of sidewall 28 of tubular member 20 and the combined width W₅ of clamps 44, 46. Bar 48 includes an aperture 60 proximate each end wherein each aperture 60 is configured to coincide with the holes within flanges 52, 54 such that bolt 56 passes through a first flange 52 or 54, bar 48, and emerges out of the other of flange 52 or 54 such that nut 58 can be threaded onto bolt 56 so as to sandwich bar 48 between flanges 52 and 54. Alternatively, bar 48 may be positioned on the outward face of either flange 52, 54 before passage of bolt 56 and threading of nut 58 thereto such that the apertures within the bar and the holes within each of flanges 52, 54 may be oriented such that bar 48, when secured to pipe clamps 44, 46 rests along the outer surface of tubular member 20. Using either orientation, clamping pressure of pipe clamp 44 on pipe 16 and pipe clamp 46 on pipe 18 prevent lateral movement of the respective pipes within the individual clamps. Securing bar 48 between the two pipe clamps 44, 46 prevents withdrawal of either pipe 16 or pipe 18 from tubular member 20. In this manner, pipes 16 and 18 are secured in an end-to-end orientation within the tubular member.

Bar 48 may also provide additional support to tubular member 20 to minimize (or more preferably, prevent) flexing of tubular member 20 and joined pipes 16, 18 so as to maintain a fluid-tight fitting between the pipe ends. The apertures within bar 48 may also be formed as elongated slots 60A such that bar 48 is able to accommodate expansion/contraction of tubular member 20, first pipe 16, second pipe 18 or combinations thereof when pipe coupling 10 and pipes 16, 18 are deployed in the field and subject to the various temperature changes experienced during the growing season.

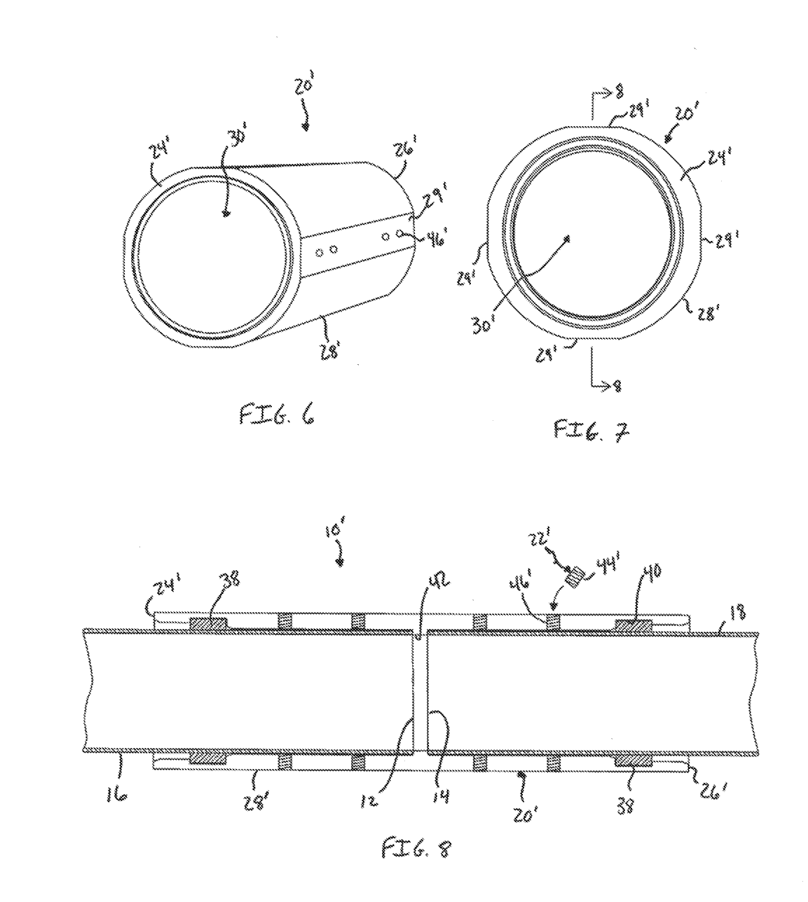

Turning now to FIGS. 6-8, an alternative embodiment of a pipe coupling in accordance with the present invention is generally indicated by reference number 10′. Pipe coupling 10′ is adapted to join pipe ends 12, 14 of opposing first and second pipes 16, 18 within a tubular member 20′ similar to that described above with regard to embodiment 10 shown in FIGS. 1-5. Similar to tubular member 20, tubular member 20′ has opposing first and second ends 24′, 26′ and a sidewall 28′ of an intermediate extent thereby defining a hollow interior 30′ with the first end 24′ being adapted to receive and surround first pipe 16 and second end 26′ being adapted to receive and surround second pipe 18. Unlike tubular member 20, tubular member 20′ has a figured outer surface of sidewall 28′ wherein sidewall 28′ includes one or more flattened surfaces 29′. The internal surface of tubular member 20′ may be substantially identical to that of tubular member 20 and may include such features as seals 38, annular groove 40 and annular projection 42.

Coupling 10′ includes a pipe retainer 22′ in the form of a threaded compressive member 44′, such as a set screw, adapted to be threadably inserted within corresponding threaded hole 46′ within sidewall 28′ of tubular member 20′. Set screw 44′ is threaded within hole 46′ until the screw impacts pipe 16, 68 to thereby generate a compressional force upon the pipe 16, 18 to thereby prevent lateral movement of the pipe 16, 18 within tubular member 20′. Any number of set screws 44′ may be used so long as these screws generate the requisite compressional force needed to prevent unwanted movement of pipe 16, 68 within tubular member 20′. It should be understood by those skilled in the art that, while described as a set screw, compressive member 44′ may be any suitable device such as, but not limited to, a thumb screw, a machine screw, a bolt, a pipe nipple or the like. Compressive member 44′ may also be a pipe nipple. Similarly, while sidewall 28′ is shown and described as having flattened surfaces 29′, those skilled in the art should recognize that a tubular member having cylindrical sidewalls similar to those shown in FIGS. 1-5 with regard to embodiment 10 may include threaded holes 46′ so as to receive respective compressive members 44′ as described above.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A coupling for joining pipe ends of opposing first and second pipes in end-to-end relation, the coupling comprising:
a) a tubular member having opposing first and second ends and a sidewall of an intermediate extent thereby defining hollow interior having a first internal diameter, the first end adapted to receive and surround the pipe end of the first pipe, the second end adapted to receive and surround the pipe end of the second pipe; and
b) a pipe retainer configured to secure each respective pipe end within the tubular member.

2. The coupling of claim 1, wherein the tubular member includes an internal annular projection wherein each of the opposing first and second pipe ends may be inserted within the hollow interior until each respective tube end abuts the internal annular projection.

3. The coupling of claim 1, wherein the tubular member includes respective first and second annular grooves located proximate respective first and second ends of the tubular member, each annular groove configured to receive a respective pipe seal.

4. The coupling of claim 3, wherein the pipe seal is comprised of an elastomeric material.

5. The coupling of claim 1, wherein the tubular member includes a respective step portion proximate respective first and second ends of the tubular member, each step portion defining a second internal diameter which is larger than the first internal diameter.

6. The coupling of claim 1, wherein the pipe retainer comprises:
a) a first pipe clamp adapted to be secured to the first pipe; and
b) a second pipe clamp adapted to be secured to the second pipe; wherein the pipe retainer is a clamp retainer bar having opposing ends with a first bar end secured to the first pipe clamp and a second bar end secured to the second pipe clamp.

7. The coupling of claim 6 wherein each pipe clamp includes a flange member wherein respective bar ends are secured to respective flange members.

8. The coupling of claim 7 wherein each bar end includes an aperture therein wherein each bar end is secured to its respective flange member via a bolt and nut.

9. The coupling of claim 8 wherein one or both apertures are an elongated slot to accommodate expansion of the tubular member, the first pipe, the second pipe or any combination thereof.

10. The coupling of claim 1, wherein the pipe retainer comprises a plurality of threaded compressive members threadably inserted within corresponding threaded holes within the tubular member, the threaded compressive members adapted to exert a compressional force upon the first and second pipes to releasably secure the pipes within the tubular member.

11. The coupling of claim 10 wherein the threaded compressive members are set screws.

12. The coupling of claim 10 wherein an outer surface of the tubular member includes a flattened portion wherein the threaded holes are located within the flattened portion.

13. A method of repairing a damaged section of pipe with a pipe coupling, wherein the pipe coupling includes a pipe retainer having a first clamp and a second clamp and an elongate retainer bar, and a tubular member having a first end and second end, the method comprising the steps of:
a. locating the damaged section of pipe;
b. removing the located damaged section to form a remaining first section of pipe having a third end and a second section having a fourth end facing the third end;
c. installing the tubular member to join the first section of pipe to the second section of pipe in an end-to-end relation so that the tubular member first end receives the third end and the tubular member second end receives the fourth end;
d. attaching the first clamp to the first section of pipe and the second clamp to the second section of pipe; and
e. securing a first end of the retainer bar to the first clamp and securing a second end of the retainer bar to the second clamp, thereby repairing the damaged section of pipe.

14. The method in accordance with claim 13 whereby the tubular member sealably joins the first section of pipe to the second section of pipe.
